(19) United States
(12) Patent Application Publication
(10) Pub. No.: US 2007/0182846 A1
(43) Pub. Date: Aug. 9, 2007

(54) Portable image pickup device

(75) Inventors: Yoshihide Uchida, Tokyo (JP); Tatsuhiko Ikehata, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/491,064

(22) Filed: Jul. 24, 2006

(30) Foreign Application Priority Data
Feb. 8, 2006 (JP) 2006-031239

(51) Int. Cl. H04N 5/225

(52) U.S. Cl. 348/376

(57) ABSTRACT

The invention provides a portable image pickup device which is capable of solving the lengthening of an activation time caused in accordance with a structure of a file system. When an operating system is activated, unused cluster information corresponding to real data stored in a hard disc drive (105) is acquired from an FSINFO region (103). Hence, it is possible to omit a work for retrieving an FAT region (124) in processing for initializing a file system, and thus it is possible to shorten a time required to initialize the file system. As a result, it is possible to shorten a time required for processing for activating the operating system, and it is possible to enhance mobility from a phase in which a power source of a portable image pickup device (1) is turned ON to a phase in which the portable image pickup device (1) becomes available.

The present application is based on Japanese patent application No. 2006-031239, the entire contents of which are incorporated herein by reference.

### BACKGROUND

1. Field

One embodiment of the invention relates to a portable image pickup device which is capable of dissolving the lengthening of an activation time caused in accordance with a structure of a file system.

2. Description of the Related Art

Some conventional image pickup devices include image pickup elements for capturing moving images or still images of subjects to output image information on the moving images or still images of the subjects, respectively. With regard to this sort of image pickup device, an image pickup device has been generally known which includes a semiconductor memory such as a flash memory as a storage portion for storing therein image information.

In addition, an image pickup device has been proposed which employs a hard disc drive as another storage portion. This image pickup device, for example, is disclosed in the Japanese Patent Kokai No. 2003-274356. The hard disc drive is suitable for a storage portion of the image pickup device in which a memory size per one file is large as required for a moving image because the cost per capacity is lower than that of the semiconductor memory.

A method of managing a folder and a file in accordance with a file system contained in an operating system for controlling operations of hardware and the like has been known as a method of managing data in the storage portion described above. A file allocation table (FAT) which is widely used in personal computers and electronic apparatuses has been known as such a file system. The FAT manages physical arrangement of a cluster, on a disc, as a unit constituting a file, and has a plurality of forms for the FAT, an FAT32 and the like in which methods of formatting data in a data storage region are different from one another, and management methods thereof are also different from one another.

When activation of the operating system is performed in accordance with turn-ON of a power source of an electronic apparatus, processing for initializing the file system is executed in accordance with the performing of the activation of the operating system. Then, a situation of use of a cluster in a storage region is grasped by retrieving an FAT region. The contents in the FAT region are successively updated to the newest ones in accordance with an operation for writing/reading of data to/from a storage region.

However, in the electronic apparatus having the conventional file system installed therein, in general, in the phase of activating the operating system, the situation of using the cluster in the storage region is grasped in accordance with the retrieval of the FAT region. As a result, it takes time to retrieve the FAT region in the storage portion, having a large storage capacity, such as the hard disc drive, and as a result, a time (hereinafter referred to “an activation time”) ranging from a phase in which the power source of the electronic apparatus is turned ON to a phase in which the electronic apparatus becomes available is lengthened to reduce the convenienceness of the electronic apparatus.

In particular, the portable image pickup device which is in the progress of coming into wide use has such a merit that image system data on a moving image, a still image or the like can be electrically preserved irrespective of any of recording media such as a film. However, in addition to miniaturization and an improvement in a battery life which do not impede the portability, enhancement of image pickup performance, and further large capacity promotion for a storage portion corresponding to large size promotion for image pickup data are required for the portable image pickup device. Under such a background, when the activation time is lengthened even if a large capacity of the storage portion is attained, nonconformity is caused such that even when a user confronts a moment at which he/she desires to photograph a subject, he/she cannot manipulate the image pickup device in an instant.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIGS. 1A and 1B are respectively an exemplary perspective view when a portable image pickup device according to a first embodiment of the present invention is viewed from a battery cover side, and an exemplary perspective view when the portable image pickup device shown in FIG. 1A is viewed from a liquid crystal display portion side;

FIG. 2 is an exemplary block diagram of the portable image pickup device according to the first embodiment of the present invention;

FIG. 3 is an exemplary diagram showing state transition ranging from turn-ON of a power source of the portable image pickup device according to the first embodiment of the present invention to completion of activation of an operating system in the portable image pickup device according to the first embodiment of the present invention;

FIG. 4 is an exemplary diagram structurally showing data stored in a hard disc drive in the portable image pickup device according to the first embodiment of the present invention;

FIG. 5 is an exemplary flow chart showing processing for activating an operating system in the portable image pickup device according to the first embodiment of the present invention;

FIG. 6 is an exemplary overall view showing a connection form of a portable image pickup device according to a second embodiment of the present invention;

FIG. 7 is an exemplary flow chart explaining an operation when image data is transferred from the image pickup device according to the second embodiment of the present invention to a personal computer (PC) apparatus under a file system of the PC apparatus;

FIG. 8 is an exemplary overall view showing a connection form of a portable image pickup device according to a third embodiment of the present invention;

FIG. 9 is an exemplary flow chart explaining an operation when image data is transferred from the portable image pickup device according to the third embodiment of the present invention to a recording/reproducing apparatus under a file system of the portable image pickup device according to the third embodiment of the present invention;

FIG. 10 is an exemplary flow chart showing an operation when shut down is suddenly caused due to apparatus abnormality caused in the portable image pickup device shown in FIG. 8, e.g., due to falling-off of a battery, an interruption of the power supply caused during use of an AC adapter, or the like; and

FIG. 11 is an exemplary flow chart explaining an operation when shut down is required due to apparatus abnormality caused in the portable image pickup device shown in FIG. 8, e.g., due to freeze or the like of the portable image pickup device shown in FIG. 8.

### DETAILED DESCRIPTION OF PREFERRED EMBODIMENTS

Various embodiments according to the invention will be described hereinafter with reference to the accompanying drawings. In general, according to one embodiment of the invention, there is provided a portable image pickup device, including: a control portion for instructing a storage portion to store therein data generated based on an image pickup operation in accordance with management made by a file system; and an unused region information-storing portion provided in the storage portion for storing therein information representing a data storage state based on an idle capacity of the storage portion in which the data managed by the file system is recordable.

In addition, according to one embodiment of the invention, there is provided a portable image pickup device, including: a control portion for instructing a storage portion to store therein data on an image captured with an image pickup element in accordance with management made by a file system; and an unused region information-storing portion provided in the storage portion for storing therein unused region information based on an idle capacity of the storage portion in which the image data managed by the file system is recordable.

Also, according to one embodiment of the invention, there is provided a portable image pickup device, including: a control portion for instructing a hard disc drive to store therein data on an image captured with an image pickup element in accordance with management made by a file system; and an unused cluster information-storing portion provided in the hard disc drive for storing therein unused cluster information based on an idle capacity of the hard disc drive in which the image data managed by the file system is recordable.

According to the present invention, it is possible to dissolve the lengthening of the activation time caused in accordance with the structure of the file system.

### First Embodiment

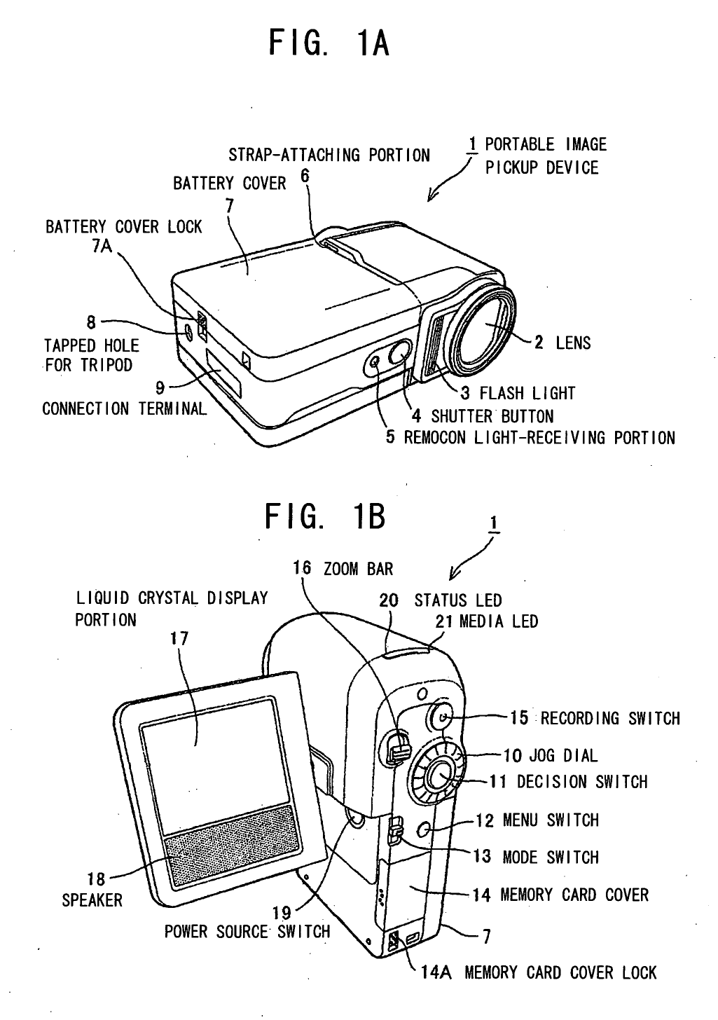

FIGS. 1A and 1B are respectively a perspective view when a portable image pickup device 1 according to a first embodiment of the present invention is viewed from a battery cover 7 side, and a perspective view when the portable image pickup device 1 shown in FIG. 1A is viewed from a liquid crystal display portion 17 side.

### Construction of Portable Image Pickup Device 1

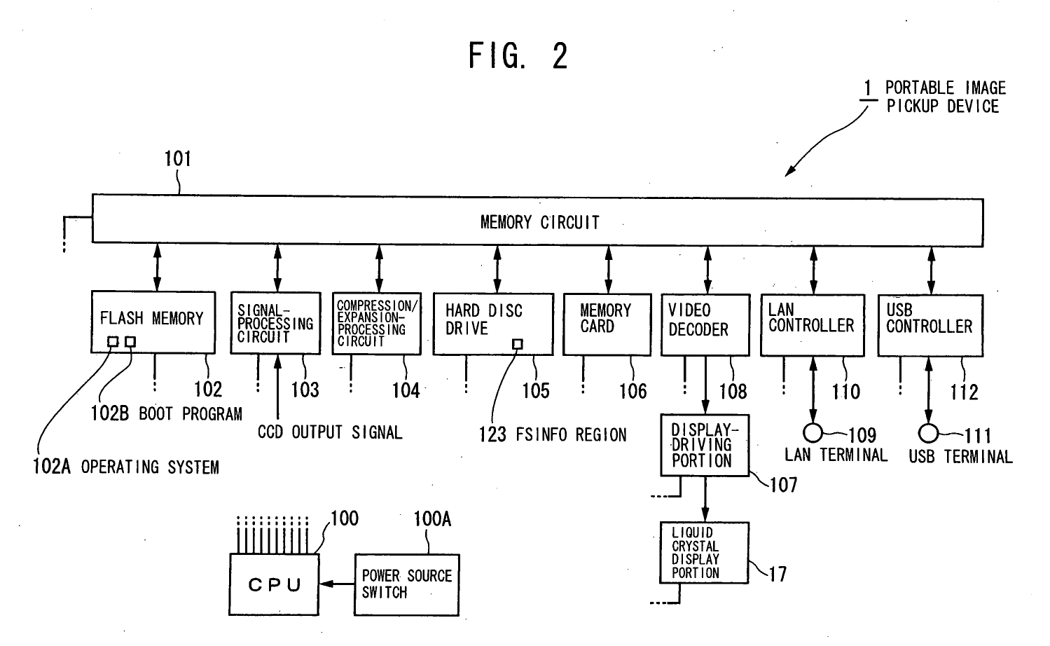

The portable image pickup device 1 includes a lens 2, a flash light 3, a shutter button 4 with which a still image is photographed, a remocon light-receiving portion 5 for receiving a light radiated from a light-emitting portion of a remocon device (not shown), a strap-attaching portion 6 into which a hand strap (not shown) is inserted for its attachment, the battery cover 7 which is movably attached to a main body of the portable image pickup device 1, a tapped hole 8 for a tripod, a connection terminal 9 which is connected to a connection adapter (not shown), a jog dial 10 for selecting desired one among set items about the portable image pickup device 1, and a decision switch 11 with which a decision manipulation is performed for various settings. Also, the portable image pickup device 1 includes a menu switch 12 with which various menus are displayed on the liquid crystal display portion 17 which will be described later, a mode switch 13 with which a reproduction mode and a recording (for a still image and a moving image) mode are changed to each other, a memory card cover 14 for protecting a memory card detachably inserted into the main body, a recording switch 15 with which a moving image is photographed, a zoom bar 16 with which a zooming manipulation is performed while a still image and a moving image are photographed, the liquid crystal display portion 17, a speaker 18 provided on a lower side of the liquid crystal display portion 17, a power source switch 19, a status LED 20 for showing an operation state of the portable image pickup device 1, and a media LED 21 which is adapted to be turned ON in correspondence to a state of access to a memory card 106 (refer to FIG. 2).

A still image is photographed by manipulating the shutter button 4 when the mode switch 13 is set to an image photographing mode. Focusing and exposure adjustment are performed by half-depressing the shutter button 4 (half-shutter manipulation), so that data on ISO sensitivity, data on a shutter speed, and a stop value are displayed on the liquid crystal display portion 17. In addition, a still image can also be photographed by manipulating the shutter button 4 while a moving image is photographed.

The battery cover 7 prevents a lithium ion battery as a power source built in the main body from dropping out by its battery cover lock 7A.

A connection adapter (not shown) including a universal serial bus (USB) terminal, a power source terminal, and an AV terminal is connected to the connection terminal 9, whereby an AV output and USB connection can be made through the connection adapter.

The memory card cover 14 can be opened and closed by releasing the memory card cover lock 14A. In this embodiment, an SD memory card is used as the memory card 106.

A moving image is photographed by manipulating the recording switch 15 when the mode switch 13 is set to the image photographing mode.

The liquid crystal display portion 17 is accommodated together with the speaker 18 in the same panel. This panel is closably and rotatably pivoted to the main body. In addition, in the accommodation state, a formation surface of the liquid crystal display portion 17 and the speaker 18 is directed to the main body side, and a rear side thereof is flush with an external form of the main body.

The power source switch 19 is used when the portable image pickup device 1 is turned ON or OFF with the liquid crystal display portion 17 being opened. Incidentally, the power source of the portable image pickup device 1 is turned ON by opening the liquid crystal display portion 17, while the power source thereof is turned OFF by closing the liquid crystal display portion 17.

In the portable image pickup device 1, an imaging optical system and a solid state image pickup element (which are not shown in FIGS. 1A and 1B) are installed in an upper portion of the main body, i.e., in the rear of the lens 2. The solid state image pickup element corresponds to the photographing of a still image and a moving image.

FIG. 2 is a block diagram of the portable image pickup device 1 according to the first embodiment of the present invention. Incidentally, only main portions of the portable image pickup device 1 are shown in the figure.

The portable image pickup device 1 includes a CPU 100 as a control portion for controlling operations of portions, a power source switch 100A with which the power source of the portable image pickup device 1 is turned ON/OFF, a memory circuit 101, a flash memory 102 in which an operating system 102A for controlling the portable image pickup device 1 and a boot program 102B required to activate the operating system 102A are stored, a signal-processing circuit 103 for signal-processing an image signal outputted from an image pickup element, and a compression/expansion-processing circuit 104 for subjecting the image signal to compression/expansion processing. Also, the portable image pickup device 1 includes a hard disc drive 105 as a large-capacity memory, the memory card 106 constituted by a non-volatile memory, a display-driving portion 107 for driving the liquid crystal display portion 17, a video decoder 108 for generating an image signal an image corresponding to which is displayed, a local area network (LAN) controller 110 connected to a LAN terminal 109, and a USB controller 112 connected to a USB terminal 111.

The memory circuit 101 is provided between the control portion 100 and each of the portions, and serves to temporarily hold therein a signal which has a large amount of data and which is outputted from the CPU 100.

The signal-processing circuit 103 executes predetermined signal processing for a CCD output signal as an image signal.

The compression/expansion-processing circuit 104 executes processing for compressing/expanding the CCD output signal in correspondence to a still image or a moving image. In this embodiment, the compression/expansion-processing circuit 104 executes processing for compressing/expanding the still image in accordance with the joint photographic expert group (JPEG) standards. On the other hand, the compression/expansion-processing circuit 104 executes processing for compressing/expanding the moving image in accordance with the motion picture expert group (MPEG) standards.

The hard disc drive 105 is a storage portion for managing image data on a still image, a moving image and the like which is recorded in accordance with a file system of the FAT32, audio data which is recorded together with the image data, and other data. The hard disc drive 105 has an FSINFO region 123 as an unused cluster information-storing portion for storing therein unused cluster information in an FAT region which will be described later.

The video decoder 108 decodes the CCD output signal based on an image captured with an image pickup element (not shown) to signal-process the resulting signal the image corresponding to which is then displayed on the liquid crystal display portion 17, and outputs the resulting signal to the display-driving portion 107.

The LAN controller 110 of the portable image pickup device 1 transmits/receives control signals, and data on a still image or data on a moving image to/from an external apparatus through the LAN terminal 109.

The USB controller 111 transmits/receives data on a still image or data on a moving image to/from a personal computer or any other suitable electronic apparatus through the USB terminal 111.

The CCD output signal is converted into a digital signal in an A/D-converting portion (not shown), and the resulting digital signal is inputted to the signal-processing circuit 103 to be subjected to predetermined signal processing in the signal-processing circuit 103. After that, the resulting signal is subjected to the compression processing in the compression/expansion-processing circuit 104, and is then recorded in the hard disc drive 105 or the memory card 106 through the memory circuit 101. At this time, the photographed image is displayed on the liquid crystal display portion 17 through the video decoder 108 and the display-driving portion 107.

In addition, during the reproducing operation, the data on the image read out from the hard disc drive 105 or the memory card 106 is inputted to the compression/expansion-processing circuit 104 through the memory circuit 101 and is subjected to the expansion processing in the compression/expansion-processing circuit 104. After that, the resulting data on the image concerned is outputted to the video decoder 108 through the memory circuit 101 and the image concerned is then displayed on the liquid crystal display portion 17 through the display-driving portion 107.

When data on a still image or data on a moving image which is recorded in the hard disc drive 105 or the memory card 106 is transferred or received to or from the external apparatus, the USB controller 112 transmits or receives the data to or from the external apparatus through the USB terminal 111. This operation is performed on the assumption that the external apparatus is the personal computer (PC).

In addition, the data on a moving image which is compressed in accordance with the MPEG standards can be directly transmitted/received to/from a recording/reproducing apparatus such as a digital versatile disc (DVD) recorder. In general, when such image data is transferred to the DVD recorder, the data on the moving image which is compressed in accordance with the MPEG standards is decoded on the image pickup device side, the resulting analog signal is outputted through a video terminal or S terminal and is re-compressed on the recording/reproducing apparatus side, and the resulting signal is then preserved.

With this method, for example, it takes one hour to record data on a moving image recorded for one hour in the DVD recorder. However, in this case, the data on the moving image which is compressed in accordance with the MPEG standards can be transferred in the form of a streaming to the DVD recorder through a network as it is. Although depending on a compression rate as well, a transfer time can be attained which is 1/(several tens times as short as that of the real time, and the high image quality can be maintained as it is because no re-encoding is executed. For example, when the transfer time is 1/10 times as short as that of the real time, it takes only six minutes to record the data on the moving image recorded for one hour in the DVD recorder. When the LAN is supposed as the network, the LAN controller 110 transmits/receives the image data to/from the external apparatus through the LAN terminal 109. Incidentally, the image the data on which is transferred to the DVD recorder is not limited to the moving image, and the data on the still image or the image data containing audio data may also be transferred to the DVD recorder.

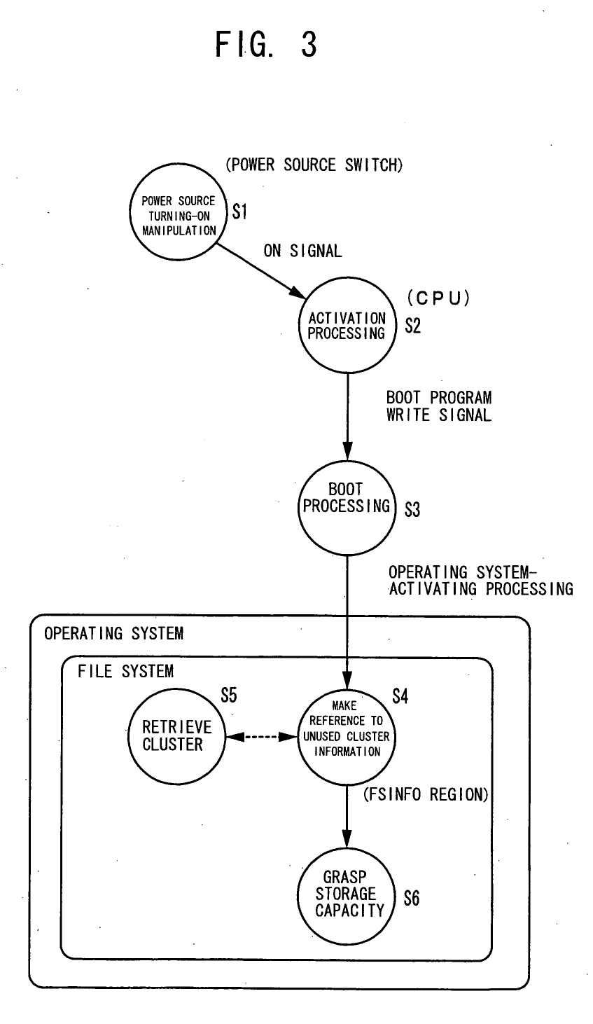

FIG. 3 is a diagram showing state transition ranging from turn-ON of the power source of the portable image pickup device 1 according to the first embodiment of the present invention to completion of activation of the operating system 102A in the portable image pickup device 1 according to the first embodiment of the present invention.

When the power source is turned ON by turning ON the power source switch 100A in the portable image pickup device 1 (S1), an ON signal is inputted to the CPU 100 through the power source switch 100A. The CPU 100 executes processing for activating the operating system 102A in accordance with the ON signal inputted thereto (S2), and executes boot processing for writing the boot program 102B stored in the flash memory 102 to a working region of the flash memory 102 to execute the boot program 102B (S3).

Likewise, the CPU 100 executes processing for activating the operating system 102A by writing the operating system 102A stored in the flash memory 102 to the working region of the flash memory 102 to execute the operating system 102A. Processing for initializing a device driver for controlling the portions of the portable image pickup device 1, and processing for initializing the file system are executed in the processing for activating the operating system 102A.

In a stage of the processing for initializing the file system, a storage capacity for data storable in a data region of a hard disc drive 105 is grasped (S6) through unused cluster information reference (S4) in which reference is made to how many unused clusters exists in total number, and retrieval (S5) of the clusters corresponding to the operation of the portable image pickup device 1, thereby completing the processing for activating the operating system 102A.

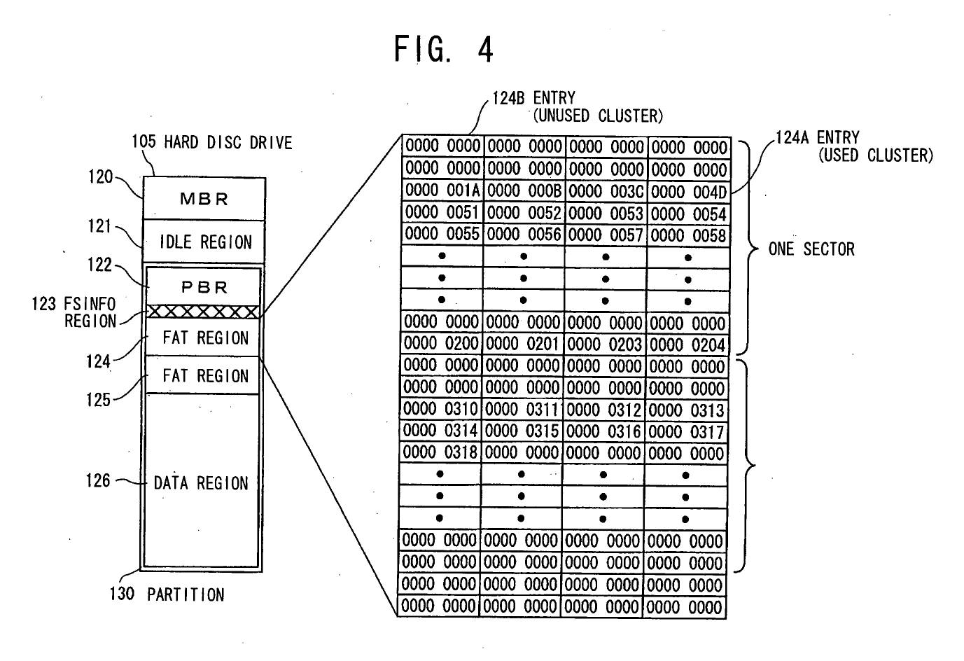

FIG. 4 is a diagram structurally showing data stored in the hard disc drive 105 in the portable image pickup device 1.

An ID or the like representing a position and a size of a partition, as a logically separated region, constituting the hard disc drive 105, and a kind of operating system is recorded in a partition table provided in a sector in a head region. An activating program is read out from an active partition with a master boot code. The partition table and the master boot code are recorded in a master boot record (MBR) 120. As shown in FIG. 4, the MBR 120, an idle region 121, and a partition 130 are arranged in the hard disc drive 105.

The partition 130 includes a partition boot record (PBR) 122 which is provided in a head region of the active partition and which is written to the flash memory 102 in accordance with the MBR 120 described above to be executed when the operating system is activated, an FSINFO region 123 in which unused cluster information in FAT regions 124 and 125 as will be described later is recorded, an FAT region 124 in which arrangement of the cluster of the file in the hard disc drive 105 is recorded, an FAT region 125 as a backup region for the FAT region 124, and a data region 126 in which a directory entry having a file name, an extension, an attribute, production date and time, a head cluster number, and a size or the like of the file stored therein, and real data corresponding to the directory entry are recorded.

Entries 124A and 124B which correspond to the respective clusters and in which the respective files are recorded are provided in the FAT region 124, and numbers such as “0000 0000” and “0000 00XX” are assigned to the individual entries, respectively. No file is stored in the entry 124B having such a number of “0000 0000” assigned thereto, and thus the entry 124B means the unused cluster. The overall unused clusters are stored in the FSINFO region 123. The file is stored in the entry 124A having the number such as “0000 00XX” to which the numerical characters other than “0” are assigned. Thus, the entry 124A means the used cluster. Incidentally, in this case, one sector corresponds to 512 bytes.

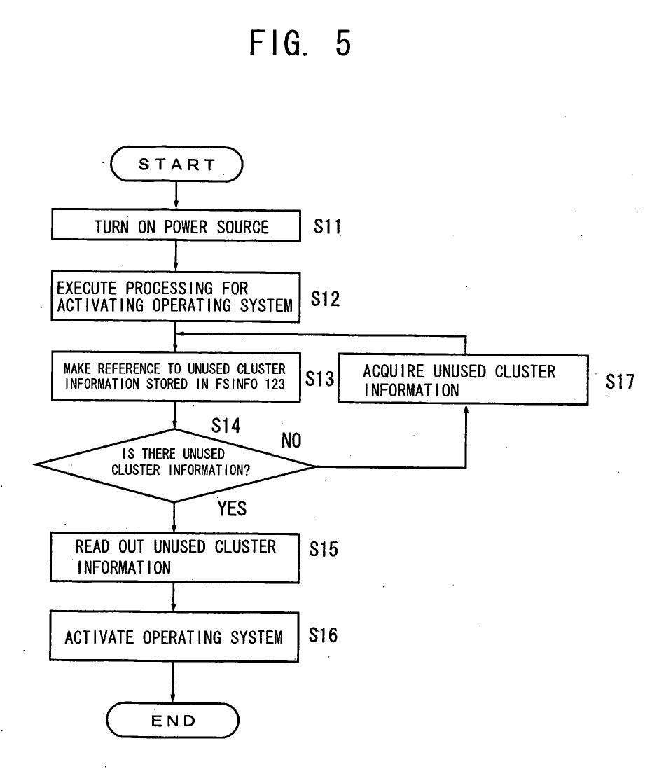

FIG. 5 is a flow chart showing processing for activating the operating system 102A in the portable image pickup device 1 according to the first embodiment of the present invention. A state from a phase in which the power source of the portable image pickup device 1 is turned ON to a phase in which the portable image pickup device 1 becomes available will be described hereinafter with reference to FIGS. 1 to 4.

Firstly, the operation for turning ON the power source is performed by opening the liquid crystal display portion 17 of the portable image pickup device 1 (S1). The CPU 100 executes boot processing in accordance with the boot program 102B stored in the flash memory 102 upon turn-ON of the power source. Subsequently, the operating system 102A stored in the flash memory 102 is written to the working region of the flash memory 102 to be executed, thereby executing processing for activating the operating system 102A (S12).

Processing for initializing the device driver is executed in accordance with the activation of the operating system 102A. While processing for initializing the file system 102A is subsequently executed, reference is made to unused cluster information stored in the FSINFO region 123 (S3).

Here, when the unused cluster information is stored in the FSINFO region 123 (S14: YES), the CPU 100 reads out the unused cluster information (S15), and grasps the available storage capacity by grasping the number of available clusters in accordance with the unused cluster information without retrieving any of the FAT regions 124 and 125, thereby completing the processing for activating the operating system.

On the other hand, when no unused cluster information is stored in the FSINFO region 123 (S14: NO), the CPU 100 retrieves the entries in the FAT region 124 to acquire the unused cluster information based on the total sum of entries 124B each having the number of “0000 0000” assigned thereto, and stores the unused cluster information thus acquired in the FSINFO region 123 (S15).

Thus, the unused cluster information stored in the FSINFO region 123 is preserved until the arrangement of the FAT region 124 is changed through the reading/writing of the data. Whenever the arrangement of the FAT region 124 is changed, the old unused cluster information is successively updated to the newest one.

According to the first embodiment of the present invention, the unused cluster information corresponding to the real data stored in the hard disc drive 105 is acquired from the FSINFO region 123 when the operating system 102A is activated. As a result, it is possible to omit the work for retrieving the entries in the FAT region 124 in the processing for utilizing the file system. Thus, it is possible to shorten a time required to initialize the file system. This results in that it is possible to shorten the time required to execute the processing for activating the operating system 102A, and it is also possible to enhance the mobility from the phase in which the power source of the portable image pickup device 1 is turned ON to the phase in which the portable image pickup device 1 becomes available.

It should be noted that although the description has been given with respect to the case where the operation for turning ON the power source of the portable image pickup device 1 is performed by opening the liquid crystal display portion 17, even when the power source switch 19 provided in the main body is manipulated, the operating system 102A is activated through the same procedure.

In addition, although in the first embodiment, the description has been given with respect to the portable image pickup device 1 in which the data storage region is the hard disc drive 105, the present invention is not limited to the hard disc drive 105, and thus the present invention may also be applied to any other suitable storage device as long as it is managed by the FAT32. Thus, even when the memory card 106 such as a semiconductor memory is used, the same effects are obtained. Moreover, the memory card 106 may be detachably provided in the main body. However, since data may be read out from or written to the detachable memory card 106 in any suitable device other than the portable image pickup device 1, no unused cluster information is used at all.

In addition, in the first embodiment, the description has been given with respect to the structure in which the unused cluster information described above is stored in the FSINFO region 123. However, alternatively, for example, the unused cluster information is stored in a storage region other than the FSINFO region 123, the processing for activating the operating system 102A is caused to be associated with that storage region, and reference is made to the unused cluster information stored in the associated storage region when the operating system 102A is activated, whereby it is similarly possible to shorten the time required for the activation processing.

With the portable image pickup device 1 described above, the data on a captured image or the like can be transferred to a personal computer or any other suitable electronic apparatus which is connected to the portable image pickup device 1 through a cable or the like. In this case, when the file (e.g., the image data) is read out from or written to a storage device, the arrangement of the FAT region 124 also changes in accordance with this operation. Thus, the unused cluster information stored in the FSINFO region 123 is also updated. Update of the unused cluster information made in accordance with the data transfer will be described hereinafter.

### Second Embodiment

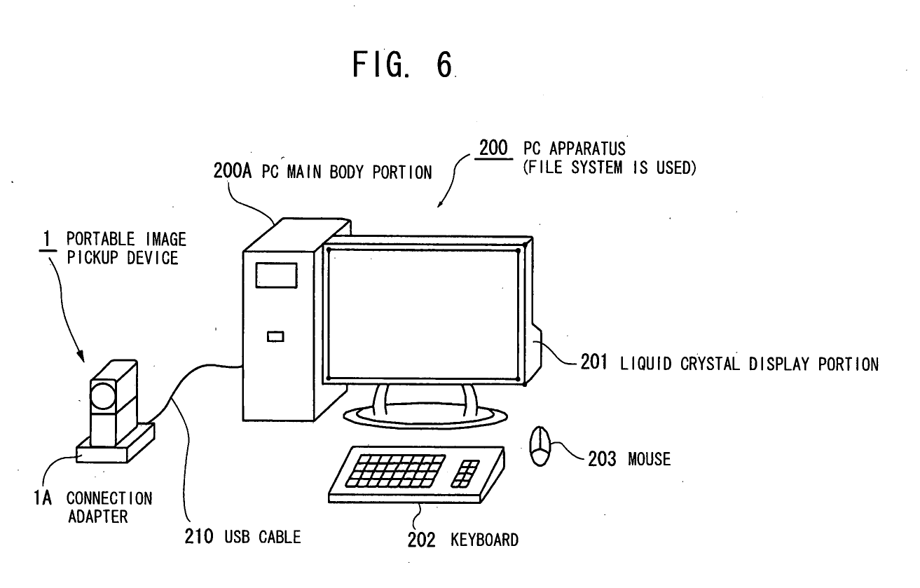

FIG. 6 is an overall view showing a connection form of a portable image pickup device 1 according to a second embodiment of the present invention. Also, FIG. 6 shows a form in which the portable image pickup device 1 is connected to a personal computer (hereinafter referred to as “a PC apparatus”) 200 through a USB cable 210. In the following description, the portions having the same constructions and functions as those in the first embodiment are designated with the same reference numerals, respectively.

The PC apparatus 200 has a PC main body portion 200A, a liquid crystal display portion 201, a keyboard 202 in which input keys such as character keys, function keys, and numerical character keys are provided in predetermined arrangement, and a mouse 203 as a pointing device for pointing to an arbitrary position on a display picture of the liquid crystal display portion 201. The arrangement of data is managed in accordance with the file system of the FAT32 similarly to the portable image pickup device 1.

The portable image pickup device 1 is connected to a connection adapter 1A including various kinds of terminal portions for cable connection, and a USB terminal of the connection adapter 1A is connected to a USB terminal of the PC apparatus 200 through the USB cable 210.

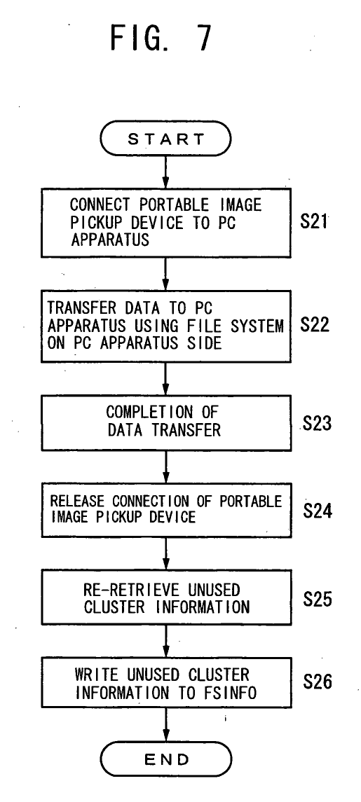

FIG. 7 is a flow chart explaining an operation when image data is transferred from the portable image pickup device 1 according to the second embodiment of the present invention to the PC apparatus 200 under a file system of the PC apparatus 200.

Firstly, the connection adapter 1A is attached to the portable image pickup device 1. In this case, the connection adapter 1A is screwed into the main body of the portable image pickup device 1 to be integrated with the portable image pickup device 1. Next, one end of the USB cable 210 is connected to the USB terminal of the connection adapter 1A, and the other end of the USB cable 210 is connected to the USB terminal of the PC apparatus 200 (S21).

When detecting the portable image pickup device 1 as an external device, the PC apparatus 200 instructs the liquid crystal display portion 201 of the portable image pickup device 1 to display thereon the data region of the portable image pickup device 1. When a user performs a manipulation for transferring the image data from the portable image pickup device 1 to a data region of the PC apparatus 200 by manipulating the keyboard 202 and the mouse 203 in accordance with the image displayed on the liquid crystal display portion 201, an animation showing the transfer state is displayed on the liquid crystal display portion 201, and also the image data is transferred to the PC apparatus 200 (S22). When the image data is normally transferred to the PC apparatus 200, the animation display showing the transfer state disappears from the picture on the liquid crystal display portion 201 (S23).

At this time, although a change occurs in the data structure of the data region 126 in the portable image pickup device 1, since the file system of the portable image pickup device 1 does not participate in the change in the data structure, the portable image pickup device 1 cannot know the change contents. For this reason, after the connection of the portable image pickup device 1 to the PC apparatus 200 is released (S24), the CPU 100 re-retrieves the FAT region 124 (S25). While the CPU 100 re-retrieves the FAT region 124, the status LED 20 of the portable image pickup device 1 is in an ON state in accordance with access to the hard disc drive 105. The CPU 100 acquires the unused cluster information after the change in the data structure by re-retrieving the FAT region 124, and stores the unused cluster information thus acquired in the FSINFO region 123 (S26).

According to the second embodiment of the present invention, even when the file is transferred from the portable image pickup device 1 to the external apparatus under the file system of the external apparatus to which the portable image pickup device 1 is connected, the unused cluster information is re-retrieved after completion of the release of the connection of the portable image pickup device 1 to the external apparatus. Hence, the precise unused cluster information is stored in the FSINFO region 123. As a result, the activation time required for the operating system activation processing after this operation is prevented from being lengthened.

In addition, in the second embodiment, the description has been given with respect to the operation for transferring the data under the file system of the external apparatus. However, the data can also be transferred to the external apparatus under the file system of the portable image pickup device 1. Since the operation in this case is different from that described above, it will be described below.

### Third Embodiment

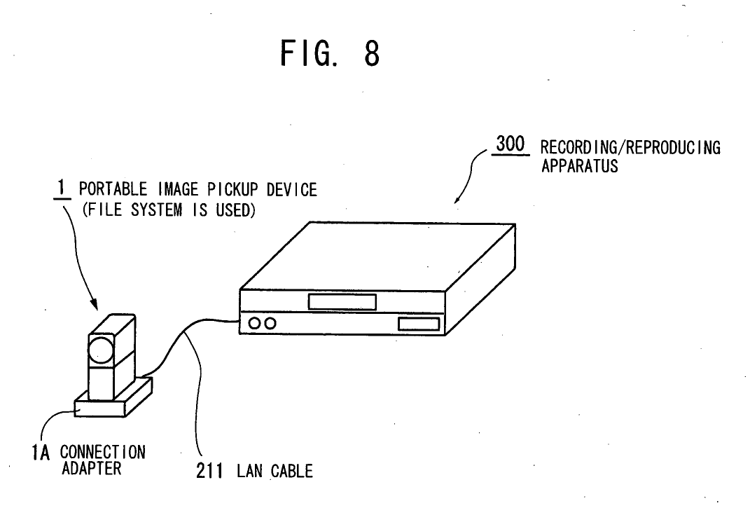

FIG. 8 is an overall view showing a connection form of a portable image pickup device 1 according to a third embodiment of the present invention. Also, FIG. 8 shows a form in which the portable image pickup device 1 is connected to a recording/reproducing apparatus 300 through a LAN cable 211. In this embodiment, a LAN terminal of the portable image pickup device 1 is connected to a LAN terminal of the recording/reproducing apparatus 300 through the LAN cable 211.

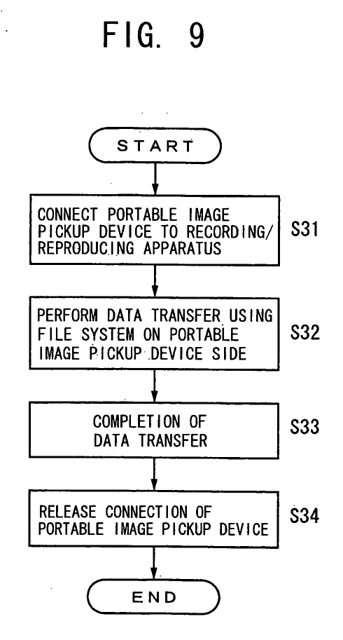

FIG. 9 is a flow chart explaining an operation when the image data is transferred from the portable image pickup device 1 of the third embodiment of the present invention to the recording/reproducing apparatus 300 under the file system of the portable image pickup device 1.

Firstly, one end of the LAN cable 211 is connected to the LAN terminal of the connection adapter 1A attached to the portable image pickup device 1, and the other end of the LAN cable 211 is connected to the LAN terminal of the recording/reproducing apparatus 300 (S31). After completion of the connection, the portable image pickup device 1 executes processing for synchronization with the recording/reproducing apparatus 300.

Next, the user selects the jog dial 10, the decision switch 11 and the like to instruct the portable image pickup device 1 to transfer the file while looking at a file selection picture displayed on the liquid crystal display portion 17 of the portable image pickup device 1, whereby the data is transferred from the portable image pickup device 1 to the recording/reproducing apparatus 300 (S32). A display image showing that the data is being transferred from the portable image pickup device 1 to the recording/reproducing apparatus 300 is displayed on the liquid crystal display portion 17 while the processing for transferring the data is executed, and when the data transfer is completed, that display image disappears from the picture on the liquid crystal display portion 17 (S33).

When the data transfer processing is executed under the file system of the portable image pickup device 1, even if a change occurs in the data structure of the data region 126, the file system of the portable image pickup device 1 grasps an amount of data transferred. Thus, there is no need for re-retrieving the FAT region 124, and the connection of the portable image pickup device 1 to the recording/reproducing apparatus 300 is released, thereby completing the data transfer processing (S34).

According to the third embodiment of the present invention, when the data is transferred under the file system on the portable image pickup device 1 side, the file system grasps an amount of data transferred. As a result, the unused cluster information in the FSINFO region 123 can be updated to a precise value, and the re-retrieval of the FAT region 124 after completion of the release of the connection can be made unnecessary. Thus, the current mode can be speedily returned back to the image photographing mode.

Even when the relationship of master and servant about the apparatus to which the portable image pickup device 1 is connected differs with respect to the file system, the precise unused cluster information can be stored in the FSINFO region 123. However, when nonconformity unexpectedly occurs in the portable image pickup device 1, there is the possibility that the nonconformity is caused in the file system. For example, when the supply of the power is interrupted due to consumption of the battery remaining power, any of the operations of the portable image pickup device 1 is stopped. Then, a method of coping with such a situation will be described hereinafter.

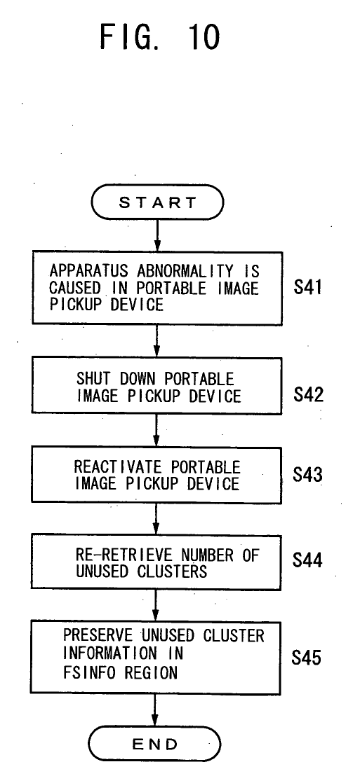

FIG. 10 is a flow chart showing an operation when a shut down is suddenly caused due to apparatus abnormality caused in the portable image pickup device 1 shown in FIG. 8, e.g., due to falling-off of a battery, an interruption of the power supply caused during use of an AC adapter, or the like.

When apparatus abnormality is caused in the portable image pickup device 1 (S41), and shut down is performed (S42), in the case concerned with the power source, after the surroundings of the power source are restored, the power source of the portable image pickup device 1 is turned ON and the operating system 102A is re-activated (S43). At this time, since there is the possibility that the unused cluster information cannot be updated in the shut down which is formerly performed, the FAT region 124 is re-retrieved to acquire the newest unused cluster information (S44), and the newest unused cluster information thus acquired is stored in the FSINFO region 123 (S45). In and after this operation, the file system can grasp the precise unused cluster information.

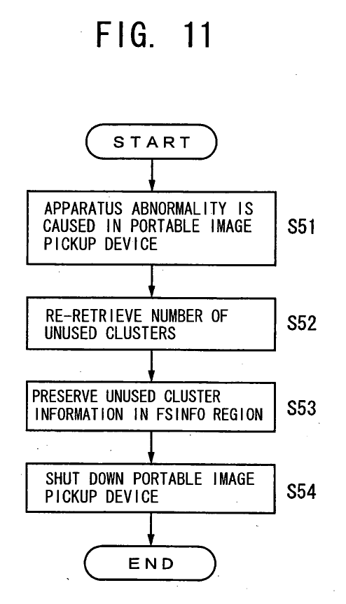

FIG. 11 is a flow chart explaining an operation when shut down is required due to apparatus abnormality caused in the portable image pickup device 1 shown in FIG. 8, e.g., due to freeze of the portable image pickup device 1 shown in FIG. 8 or the like.

In such a case, when the apparatus abnormality is caused in the portable image pickup device 1 (S51) and a forced completion manipulation is carried out by depressing continuously the power source switch 19, the CPU 100 re-retrieves the FAT region 124 to acquire the newest unused cluster information right before the shut down is performed (S52), and stores the newest unused cluster information thus acquired in the FSINFO region 123 (S53). After that, the portable image pickup device 1 is shut down (S54). When the portable image pickup device 1 is then re-activated, the unused cluster information stored in the FSINFO region 123 is effective in this operation. As a result, it is possible to shorten the time required to activate the operating system.

It should be noted that the present invention is not intended to be limited to the first to third embodiments described above, and the various combinations and changes thereof can be made without departing from or changing the technical idea of the invention.

What is claimed is:

1. A portable image pickup device, comprising:
a control portion for instructing a storage portion to store therein data generated based on an image pickup operation in accordance with management made by a file system; and
an unused region information-storing portion provided in the storage portion for storing therein information representing a data storage state based on an idle capacity of the storage portion in which the data managed by the file system is recordable.

2. A portable image pickup device according to claim 1, wherein:
the storage portion is a hard disc drive or a semiconductor memory.

3. A portable image pickup device according to claim 2, wherein:
the semiconductor memory is a detachable flash memory.

4. A portable image pickup device, comprising:
a control portion for instructing a storage portion to store therein data on an image captured with an image pickup element in accordance with management made by a file system; and
an unused region information-storing portion provided in the storage portion for storing therein unused region information based on an idle capacity of the storage portion in which the image data managed by the file system is recordable.

5. A portable image pickup device according to claim 4, wherein:
the storage portion is a hard disc drive or a semiconductor memory.

6. A portable image pickup device according to claim 5, wherein:
the semiconductor memory is a detachable flash memory.

7. A portable image pickup device, comprising:
a control portion for instructing a hard disc drive to store therein data on an image captured with an image pickup element in accordance with management made by a file system; and
an unused cluster information-storing portion provided in the hard disc drive for storing therein unused cluster information based on an idle capacity of the hard disc drive in which the image data managed by the file system is recordable.

8. A portable image pickup device according to claim 7, wherein:
when data is transferred to an external apparatus to which the portable image pickup device is connected under the file system of the external apparatus, the unused cluster information-storing portion re-retrieves the unused cluster information based on the idle capacity of the hard disc drive after completion of the data transfer.

9. A portable image pickup device according to claim 7, wherein:
when data is transferred to an external apparatus to which the portable image pickup device is connected under the file system of the portable image pickup device, the unused cluster information-storing portion does not re-retrieve the unused cluster information based on the idle capacity of the hard disk drive after completion of the data transfer.

10. A portable image pickup device according to claim 7, wherein:
when apparatus abnormality is caused in the portable image pickup device, the control portion re-retrieves the unused cluster information before a power source is interrupted.

11. A portable image pickup device according to claim 7, wherein:
when an operation for interrupting a power source is performed in accordance with apparatus abnormality caused in the portable image pickup device, the control portion re-retrieves the unused cluster information when the portable image pickup device is activated next time.
